(19) United States
(12) Patent Application Publication
(10) Pub. No.: US 2014/0198002 A1
(43) Pub. Date: Jul. 17, 2014

(54) Dipole Antenna

(71) Applicant: Roke Manor Research Limited, Romsey (GB)

(72) Inventor: John Hunt, Romsey (GB)

(73) Assignee: Roke Manor Research Limited, Romsey (GB)

(21) Appl. No.: 14/153,567

(22) Filed: Jan. 13, 2014

(30) Foreign Application Priority Data
Jan. 11, 2013 (GB) 1300513.7
Jan. 28, 2013 (GB) 1301436.0

(51) Int. Cl. H01Q 9/20

(52) U.S. Cl. CPC H01Q 9/20
USPC 343/749

(57) ABSTRACT

A dipole antenna, comprising: a dipole arrangement comprising at least a pair of antenna arms, each antenna arm having a feed end and a distal end, the feed ends positioned in proximity to each other; a feed structure, coupled to said dipole arrangement, comprising a balun for providing the antenna with a balanced feed; wherein, each antenna arm comprises: a conductive end plate, located at the distal end of the respective antenna arm; and an inductive coil, located at the feed end of the respective antenna arm.

### CROSS REFERENCE TO RELATED APPLICATIONS

This application claims priority from United Kingdom Patent Application No. 1300513.7, filed on Jan. 11, 2013, and United Kingdom Patent Application No. 1301436.0, filed on Jan. 28, 2013. Each of these prior applications is herein incorporated by reference in its entirety.

### BACKGROUND

Various embodiments relate to electrically-short high-power antennas and to the use of such antennas to generate high electric field strength at short distances from the antenna.

When roads are subjected to subzero temperatures, in the presence of moisture, ice can form on the road surface. This is undesirable as it reduces the performance of vehicles using the road, and can result in accidents. Despite advances in technology, it is common for roads to be defrosted by spreading salt or other material on the road surface in order to lower the melting point of the ice on the road surface. There is a need for more technically advanced and environmentally friendly methods for defrosting road surfaces.

### BRIEF SUMMARY

Various embodiments provide a dipole antenna, comprising: a dipole arrangement comprising at least a pair of antenna arms, each antenna arm having a feed end and a distal end, the feed ends positioned in proximity to each other; a feed structure, coupled to said dipole arrangement, comprising a balun for providing the antenna with a balanced feed; wherein, each antenna arm comprises: a conductive end plate, located at the distal end of the respective antenna arm; and an inductive coil, located at the feed end of the respective antenna arm.

Further features of embodiments are described below.

### BRIEF DESCRIPTION OF THE DRAWINGS

Embodiments will now be described, by way of example only, and with reference to the accompanying drawings, in which:

FIG. 1 is a perspective view of an antenna arrangement in accordance with various embodiments;

FIG. 2 is schematic circuit diagram of a model of the antenna of FIG. 1;

FIG. 3 shows the orientation of the antenna of FIG. 1 with respect to the plots shown in the following Figures;

FIGS. 4A to 4D shows the near-field electric field distribution of the antenna shown in FIG. 1; and

FIGS. 5A to 5D show the near-field magnetic field distribution of the antenna shown in FIG. 1.

### DETAILED DESCRIPTION

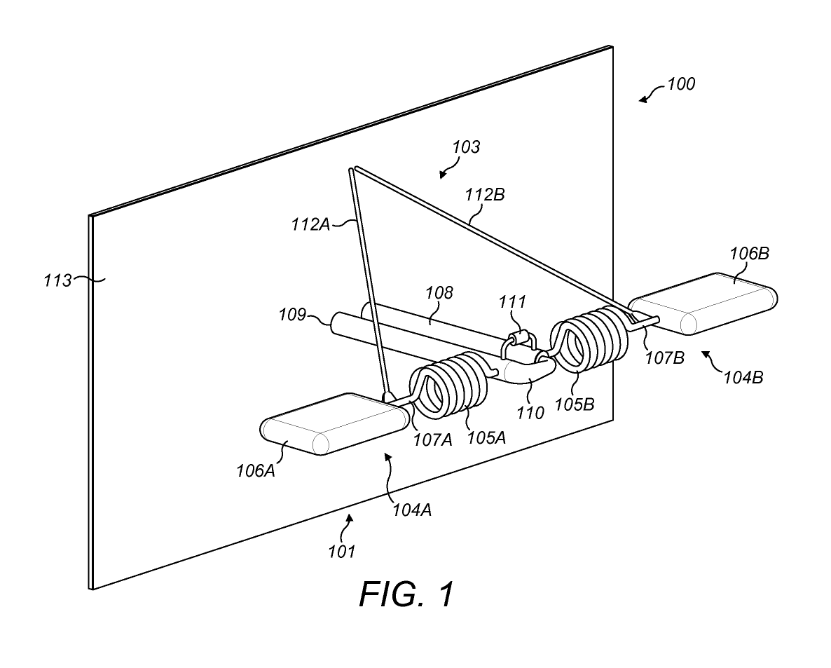

An antenna arrangement 100 in accordance with various embodiments is shown in FIG. 1. The antenna arrangement 100 includes an antenna 101 and a feed structure 102. Also shown in FIG. 1 is supporting structure 103. Antenna 101 is an electrically-short high-power dipole antenna. The dipole is formed by antenna arms 104A, 104B.

In use, the supporting structure 103 may be positioned on a vehicle, such as a car or truck. The antenna arrangement 100 is designed to be mounted on the front of such a vehicle, such that the antenna arrangement is positioned a predetermined distance above the ground. In use, the electric field generated by the antenna 101 is directed towards the ground, as will be explained in more detail below. In FIG. 1, supporting structure 103 includes a back plate, which is a reflector, as will be described in more detail below. It will be appreciated that the supporting structure may take other forms, such as an array of horizontal supporting sections.

The antenna arrangement 100 is typically positioned so that the antenna 101 is positioned around 1 m to 1.5 m above the ground. Moving the antenna 101 closer to the ground would increase the field strength on the ground, but the field would be more localised. The impendence of the antenna, and hence its efficiency, would also be reduced. Moving the antenna 101 away from the ground would decrease the field strength.

Each antenna arm 104A, 104B includes a coil 105A, 105B and a conductive end plate 106A, 106B. The coils 105A, 105B may have a value of around 5 μH (micro-Henries) each. The conductive end plates 106A, 106B are formed at distal ends of the antenna arms 104A, 104B. The coils 105A, 105B are formed at the proximal ends of the antenna arms. The conductive end plates 106A, 106B are coupled to a feed point of the feed structure 102 by conductive wires 107A, 107B. Towards the proximal end of each antenna arm 104A, 104B, the coils 105A, 105B are formed by the conductive wires 107A, 107B. As can been seen in FIG. 1, the conductive end plates 106A, 106B, conductive wires 107A, 107B and the coils 105A, 105B share a common primary axis. The antenna arms 104A, 104B arranged such their primary axes are aligned, with one arm mirroring the other, in terms of the arrangement of its components. In FIG. 1, each coil 105A, 105B is wound in the same direction and consists of six full turns. Although the antenna arms 104A, 104B are shown in a fixed position, they may be mounted on brackets that allow them to be lifted upwards. This may be useful if ground clearance is an issue, so that the antenna arrangement may be lifted away from any objects or ground protrusions.

The conductive end plates 106A, 106B are rectangular in shape and are arranged such that the short sides of each plate are connected to the conductive wires 107A, 107B. The conductive end plates 106A, 106B include a primary plane, which is aligned with a surface of the rectangle. In use, the antenna arms 104A, 104B are arranged such that this plane is substantially aligned with the horizontal, and hence the surface of the ground which is positioned below the antenna.

The feed structure 102 includes a coaxial transmission line 108. One end of coaxial transmission line 108 is coupled to an RF input which is located on the other side of the supporting structure, and which is not shown in FIG. 1. As shown in FIG. 1, the coaxial transmission line 108 abuts the back plate of the supporting structure. Where the coaxial transmission line 108 meets the back plate, a connection is made to the RF input and a matching circuit (also not shown in FIG. 1). The other end of the coaxial transmission line 108 is the feed point for antenna arms 104A, 104B.

At the feed point end of coaxial transmission line 108, the conductive wire 107B of antenna arm 104B is connected to the outer sleeve of coaxial transmission line 108. Feed structure 102 also includes cylindrical conductor 109. The cylindrical conductor may be hollow or solid, depending on the antenna design. Cylindrical conductor 109 is positioned in parallel with, and adjacent to, coaxial transmission line 108. At the feed point end of cylindrical conductor 109, the conductive wire 107A of antenna arm 104A is connected to the cylindrical conductor. Furthermore, the cylindrical conductor 109 is connected to the inner conductor of coaxial transmission line 108 by coupling member 110. At the feed point end of the coaxial transmission line 108, the cylindrical conductor 109 and the outer conductor of the coaxial transmission line are connected by high voltage capacitor 111. The high voltage capacitor 111 may have a value of around 180 pF. The cylindrical conductor 109 and the outer conductor of the coaxial transmission line 108 are connected together at the end distal from the feed end (i.e. adjacent to the supporting structure back plate). This connection is a low impedance connection.

Supporting structure 103 includes supporting arms 112A, 112B. Supporting arms 112A, 112B are connected to the conductive wires 107A, 107B of antenna arms 104A, 104B using connectors between coils 105A, 105B and conductive end plates 106A, 106B. The other ends of the supporting arms 112A, 112B are connected to reflector 113. The supporting arms 112A, 112B are made from non-conductive material.

The reflector 113 minimises currents induced on the structure (for example a vehicle) to which it is mounted. The reflector 113 also forms part of the support structure 103, which supports the radiating sections of the antenna 101. Although the antenna arrangement 100 could be mounted directly to a vehicle instead of via the support structure 103, it is preferable to mount the antenna arrangement via a support structure, because significant currents are induced in the support structure. Therefore, the use of a separate reflector 113 minimises the currents induced on the vehicle itself. A further advantage of a separate reflector is that the antenna may be optimised to the reflector 113, and the complete assembly may be readily transferred form one vehicle to another vehicle. The complete antenna arrangement 100 therefore becomes platform independent.

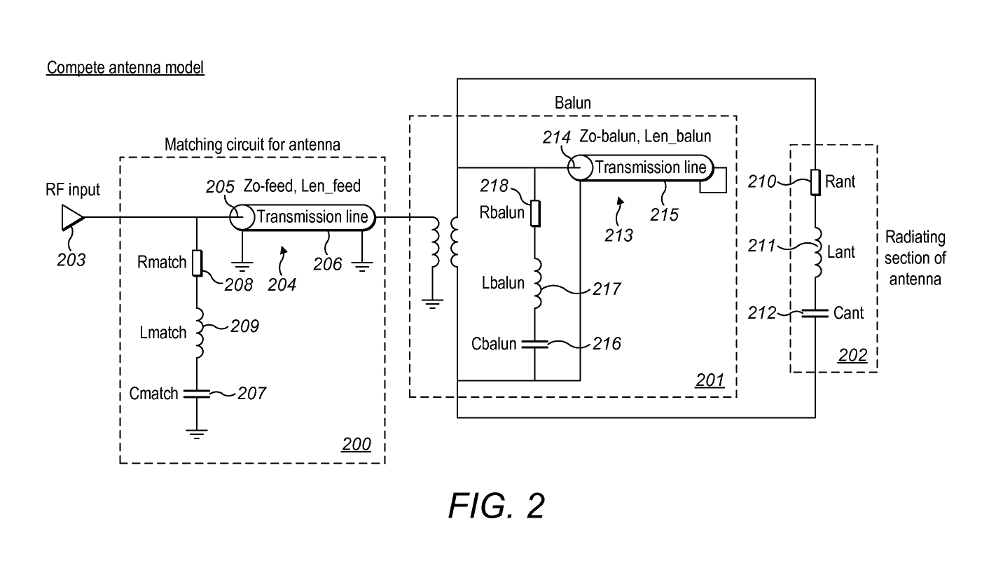

FIG. 2 is an equivalent circuit diagram of a model of antenna 101. The model shows electrical equivalents to the components of antenna arrangement 100. The model includes a matching circuit 200, a twin-line balun 201 and a radiating section 202. Also shown is RF input 203. The matching circuit 200 represents the matching circuit, which is referred to in connection with FIG. 1. The matching circuit 200 includes transmission line 204, which represents coaxial transmission line 108. Transmission line 204 includes two conductors, which are equivalent to the inner conductor and outer conductor of coaxial transmission line 108. In particular, a first conductor 205 of transmission line 204 represents the currents flowing in the inner conductor of coaxial transmission line 108. A second conductor 206 represents currents flowing on the inner surface of the outer conductor of coaxial transmission line 108. The first conductor 205 of transmission line 204 is fed by RF input 203. The second conductor 206 of the transmission line 204 is coupled to ground. This is not shown in FIG. 1. Matching circuit 200 also includes matching capacitor 207, which will have parasitic resistance 208 and parasitic inductance 209. The value of the matching capacitor will depend on the impedance to which the antenna 101 is being matched to, but may be a 1000 pF variable capacitor. The matching circuit 200 consists of the matching capacitor 207 and the transmission line 204 which are used to provide matching for the antenna 101. The matching capacitor 207 is located on the rear side of the reflector 113, and is not shown in FIG. 1.

Radiating section 202 is the electrical equivalent to the antenna arms 104A and 104B. The antenna resister 210 represents the radiation resistance of the antenna, together with the resistive losses associated with using finite conductivity materials for the antenna structure. The antenna inductor 211 and antenna capacitor 212 model the resonant behaviour of the radiating antenna structure. The antenna capacitor 212 is representative of the interaction between the conductive end plates and the ground. Similarly, the antenna inductor 211 is representative of the coils 105A and 105B.

Balun 201 includes transmission line 213. A first conductor 214 of the transmission line 213 is equivalent to the cylindrical conductor 109. A second conductor 215 of transmission line 211 is equivalent to the outer surface of the outer conductor of the coaxial transmission line 108. The two conductors of transmission line 213 appear short circuited in FIG. 2 because the cylindrical conductor 109 and coaxial transmission line 108 outer conductor are both connected together at the reflector 213. Balun 201 also includes capacitor 216, which is representative of high voltage capacitor 111. The balun also includes parasitic inductor 217 and parasitic resistor 218, which are representative of parasitic inductance and resistance generated by high voltage capacitor 111.

In the following, a description of the principles underlying the above-described antenna is provided. A dipole antenna will naturally resonate when it is just under one half of a wavelength long (around 0.48, depending upon the dipole's diameter). When a dipole is such a length, it will tend to have a large bandwidth, which means that its impedance does not change rapidly with frequency. A half-wave dipole has an impedance at resonance of around 70 ohms. It is fairly simple to transform this to 50 ohms, either through the design of the antenna or an external matching circuit. Reducing the length of a half-wave dipole will reduce its impedance, reduce its bandwidth and increase its Q. Mounting the antenna parallel to a material (the ground in this case) will alter the antenna's impedance. The amount the impedance is altered depends upon the material properties (εr & σ) and the distance between the antenna and the material.

The electrical performance of an antenna is closely related to its size in wavelengths. When the space is several wavelengths long, then a wide variety of antennas and antenna arrays may be used and the radiation bandwidth will be large. However, the performance of all antennas will be severely reduced when the space becomes electrically small. By definition, an electrically small antenna is one when ka<1, where the wave number, k is 2π/λ, and the parameter ‘a’ is half the length of the antenna's longest dimension. In the limit, the radiation quality factor, Qr tends to 1/(ka)3, as ka tends to zero. It is possible to calculate the theoretical limit for the Q of an antenna and hence its bandwidth for any VSWR (voltage standing wave ratio) and antenna efficiency.

It should be noted that a lossy or inefficient antenna will have a larger bandwidth than an efficient antenna of the same size. Most antennas require a reasonable efficiency, typically greater than 70%, but the exact figure depends upon the antenna's application. However, some wideband antennas are deliberately made lossy to improve their bandwidth. The present application requires a very efficient antenna and any losses must be minimised.

An antenna will have an input impedance:

Zin=Rin+j·Xin (1)

For an electrically-small dipole, the real part, Rin will be small and Xin will be large and negative. The purpose of loading the antenna is to reduce the magnitude of Xin to ideally zero. The loading may be performed either capacitively or inductively. The minimum value of capacitance is required at the end of the dipole arms and the minimum value of inductance is near to the centre of the antenna. A mixture of capacitive and inductive loading may also be utilised for the design presented.

The input resistance to the antenna is:

Rin=Rloss+Rr (2)

Rr is the radiation resistance, which will be of the order of a few ohms for the electrical length of the design presented. The loss resistance, Rloss, will increase the input resistance. However, the high efficiency requirement (98%) of the antenna means that the loss resistance must be of the order of tens of milliohms. The skin depth is around 0.02 mm in copper, which dictates the use of large diameter conductors.

The design of the antenna described in connection with FIGS. 1 and 2 is optimised for high power operation and a specified near-field distribution. High power operation means that the antenna design accounts for both high current sections and high voltage sections. The current in an electrically short dipole is maximum near the feed point or the centre of a dipole. Conversely, the voltage is maximum near to the end of the dipole. The high current density near the centre means that any surface resistance causes both unwanted losses and heating of the components. The loss in these areas is addressed in the current design by the selection of appropriate materials with adequate dimensions. The finite losses give rise to heating and adequate cooling is included in the design by forced air cooling. The cooling air is fed through the transmission lines 108 and 109. The voltage at the centre of the design is moderate and increases significantly at the ends of the dipole.

The operating frequency of the antenna 101 may be 13.56 MHz. At this frequency, high power off-the-shelf ruggedized RF power supplies are readily available, and may be used as the RF power source 203.

The loss requirement of the antenna 101 dictates that high conductivity metals should be used. For example, suitable materials for the antenna are copper and aluminium. At higher microwave frequencies, silver plating may be used to reduce the losses, however at the frequency of the proposed design, any plating would have to be relatively thick.

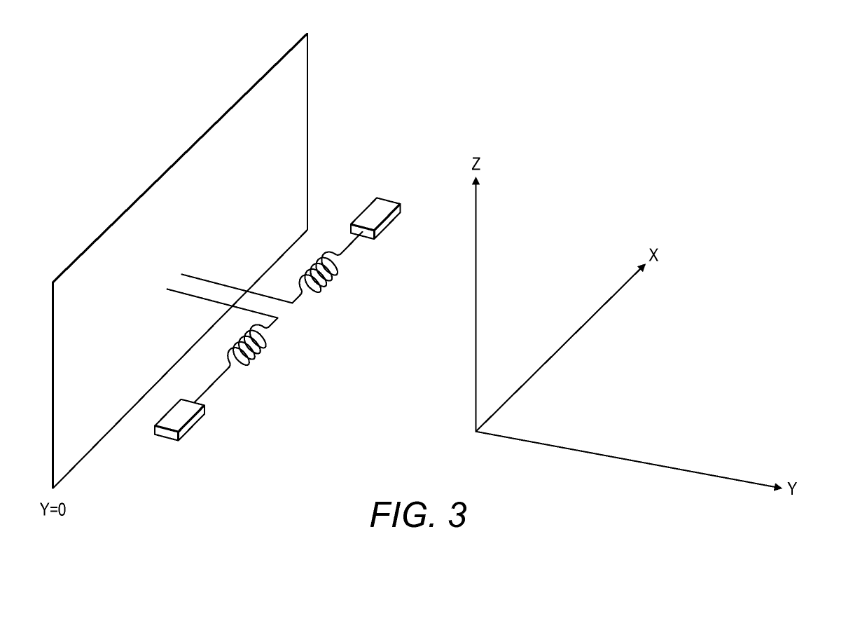

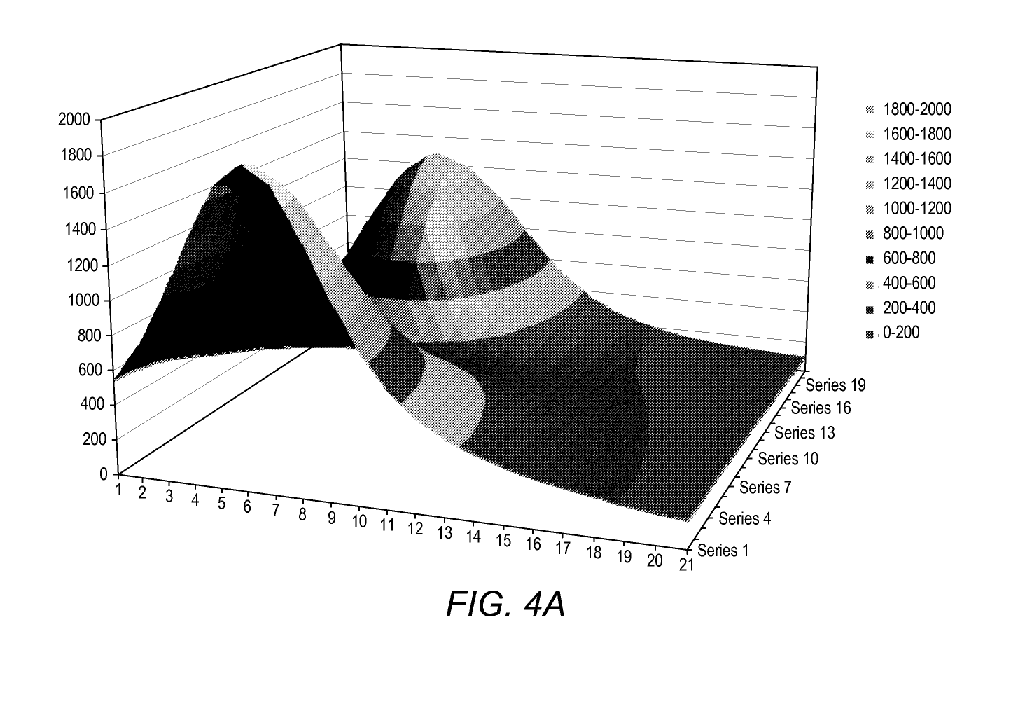

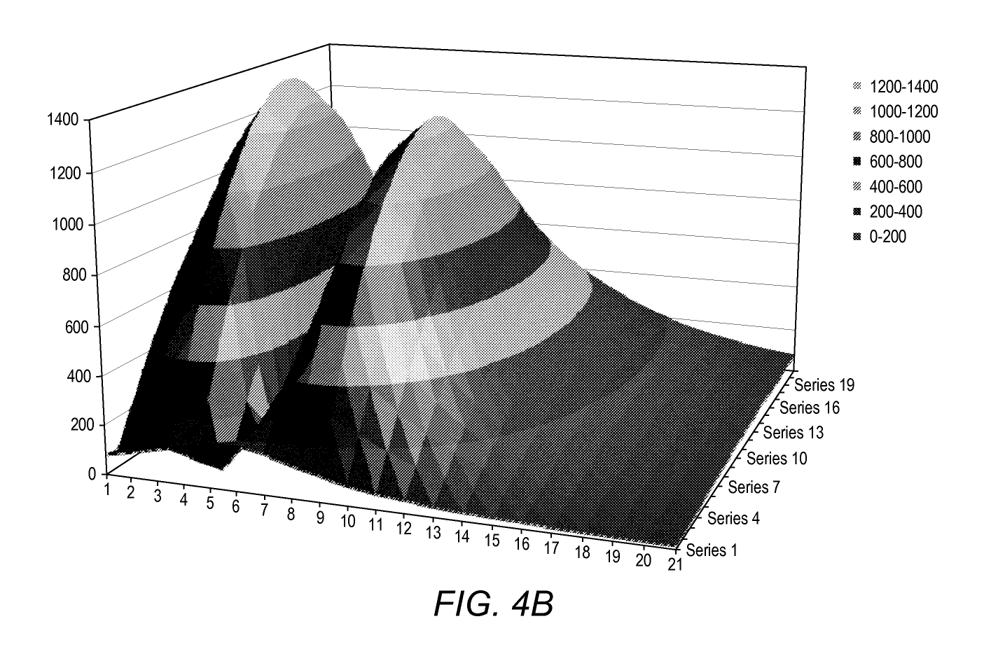

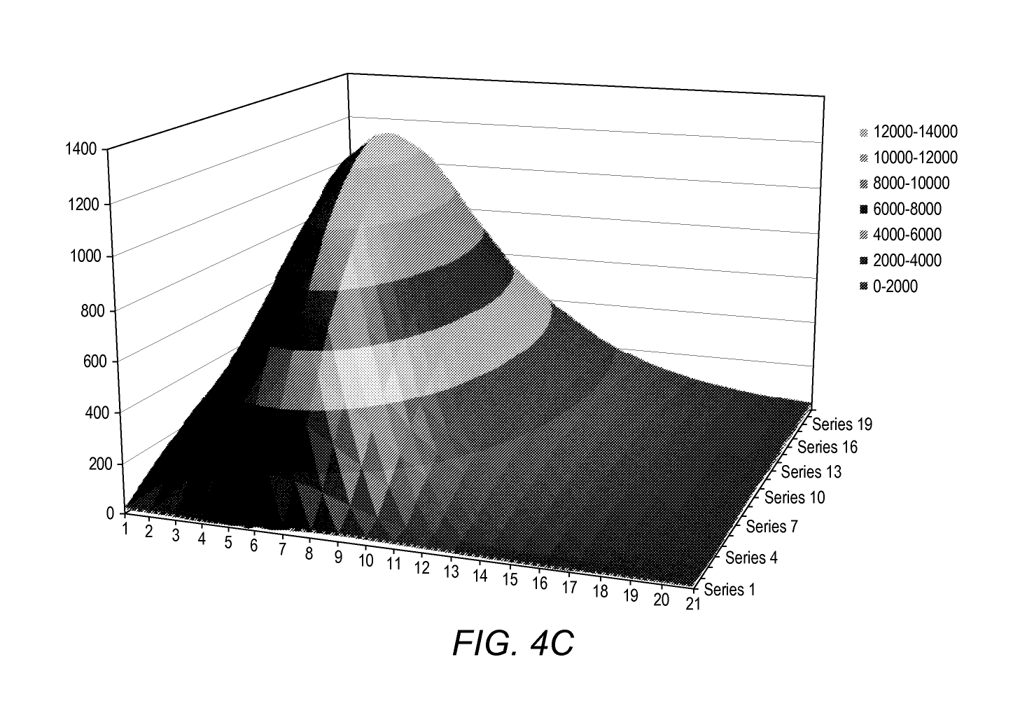

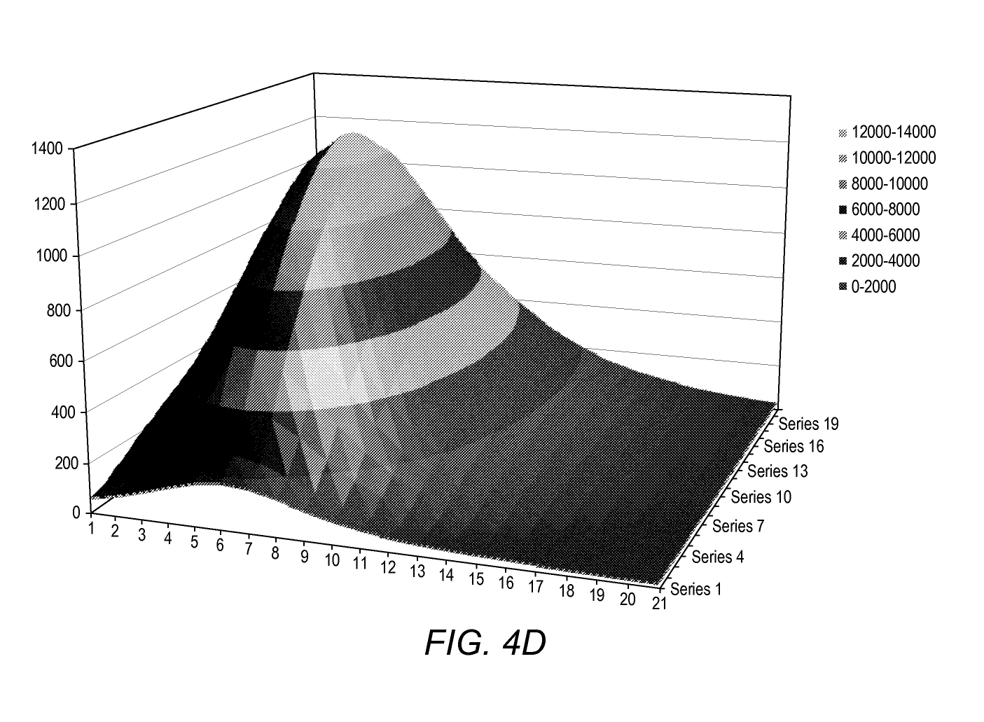

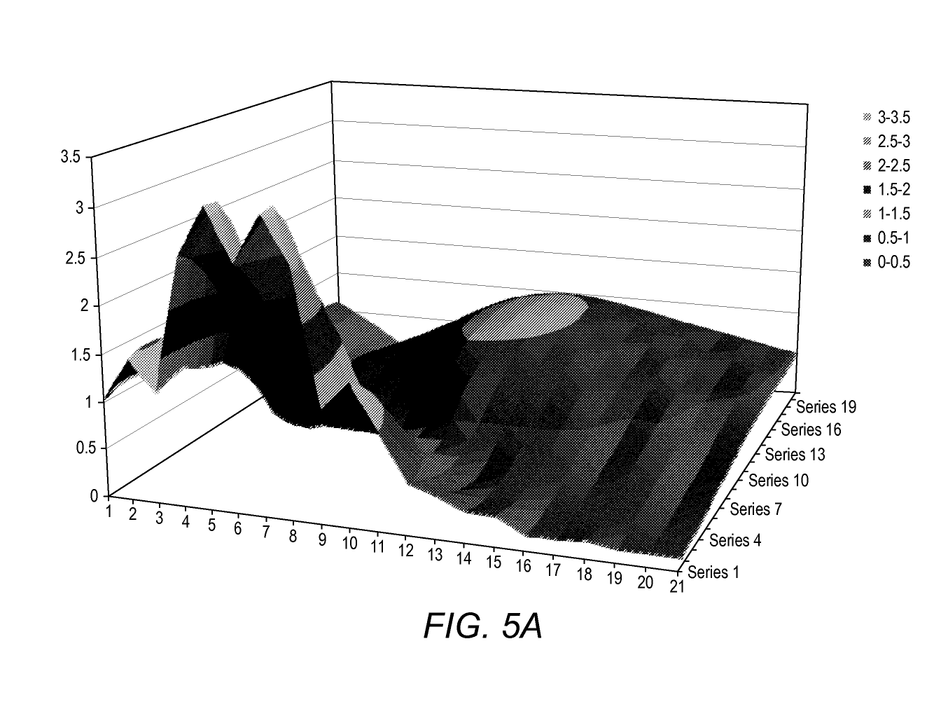

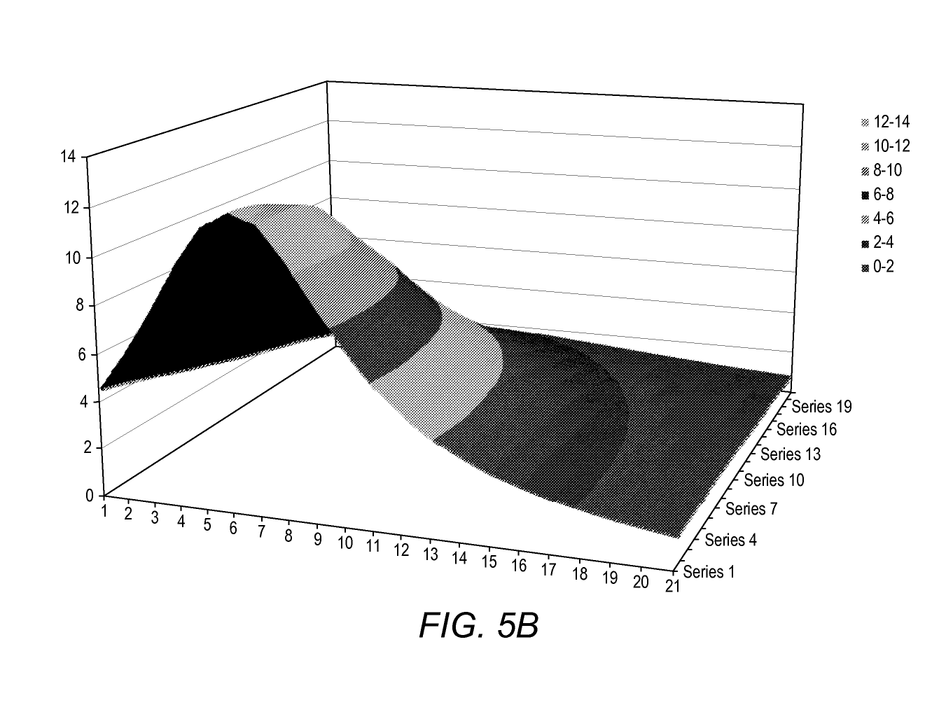

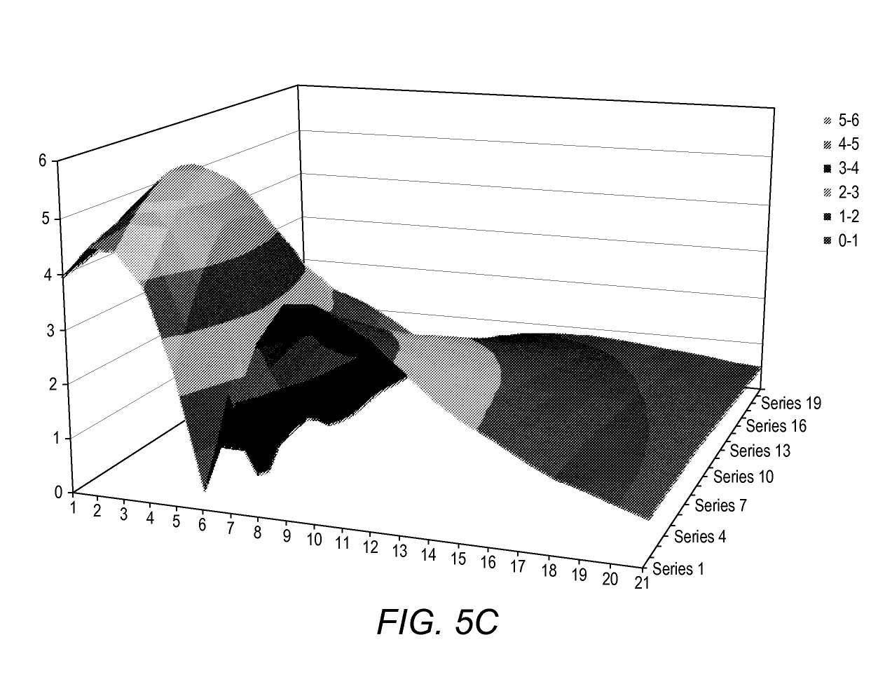

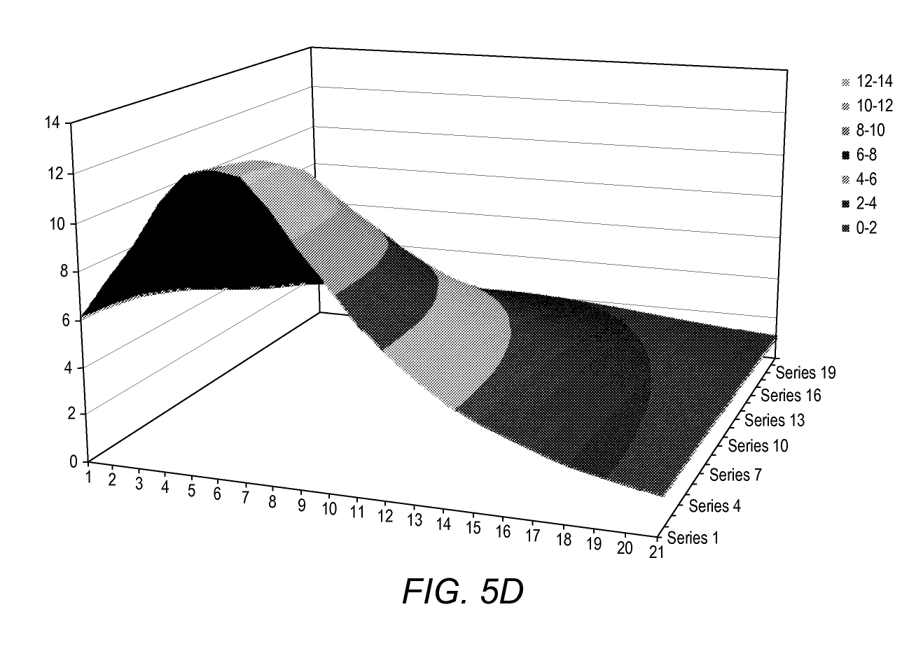

FIGS. 3, 4A to 4D and 5A to 5D show various plots relating to the near-field distribution of the antenna 101 shown in FIG. 1. FIG. 3 shows the orientation of the antenna 101 with respect to the plots of FIGS. 4A to 4D and 5A to 5D. FIGS. 4A to 4D show the near-field electric field distribution for the antenna 101. FIGS. 5A to 5B show the near-field magnetic field distribution for the antenna 101. FIG. 4A shows the Ex field on the ground about the centre line of the antenna. FIG. 4B shows the Ey field on the ground about the centre line of the antenna. FIG. 4C shows the Ez field on the ground about the centre line of the antenna. FIG. 4D shows the total electric field on the ground about the centre line of the antenna.

FIG. 5A shows the Hx field on the ground about the centre line of the antenna. FIG. 5B shows the Hy field on the ground about the centre line of the antenna. FIG. 5C shows the Hz field on the ground about the centre line of the antenna. FIG. 5D shows the total magnetic field on the ground about the centre line of the antenna.

The antenna arrangement 100 is DC grounded for safety. The DC ground is provided by the twin-line balun 201 described above. The outer surface 215 of the coaxial transmission line 108 forms one arm of the twin-line balun 201. At high frequencies, the RF currents effectively flow on the surface of a structure. In fact, the current density reduces as you move away from the surface and is negligible at distance of 5 skin depths. At high frequencies, the skin depth is fractions of a millimetre, and therefore any finite thickness tube could carry independent currents on its inside surface and its outside surface. The design of the balun 201 is such that the antenna feed currents flow on the inside surface of the outer coaxial transmission line 108. The balun currents flow on the outside surface of the outer conductor of the coaxial transmission line 108. The balun is a parallel wire transmission line that is short circuited at one end. The other end is connected to the feed point of the antenna 101.

The balun 201 is electrically shortened using high voltage capacitor 111. The balun 201 is connected across the feed point of the centre fed dipole. The input impedance of the balun 201 is required to be very high, and ideally infinite, so as to prevent loading of the antenna 101. The balun 201 would normally be designed to be one quarter of a wavelength long with a short circuit at one end. The low impedance short circuit would be transformed to a high impedance point by the action of the quarter wavelength long transmission line. In the present embodiment, there is insufficient physical space for a transmission line one quarter of a wavelength long, so the transmission line 108 is electrically loaded at its input with a lumped element, such as a capacitor 111. The capacitor reactance resonates with the impedance of the electrically short short-circuited transmission line giving rise to a high input impedance. The capacitor 111 must be a high voltage component due to the power input to the antenna.

As described above, distributed inductance loading is provided at the centre of the dipole using coupled coils 105A, 105B, having the same direction of winding. Spacing between the coil elements is designed for high power operation. An electrically-short dipole (i.e. one that is much less than one half of a wavelength long) requires either inductive or capacitive loading (or both) to make the antenna resonate and its input impedance real. The value of inductance is minimised if the inductors are located close to the centre of the dipole and conversely, the size of any capacitance is minimised if the capacitors are placed at the ends of the dipole. Any practical inductor has a physical length which means a value larger than minimum is required. The inductors for this design are physically long in order to prevent voltage breakdown between adjacent coils when operated at high powers. This large size tends to further increase the amount of inductance required. The orientation and winding direction of the two coils 105A, 105B is selected to maximise the coupling between the two coils so that the total inductance is minimised.

The coil size and position is selected for generation of the magnetic component. The large size of the coils required for high power operation, together with both coils being wound in the same direction, yields a much higher magnetic component under the centre of the antenna than would be the case under a normal design. This field also has beneficial properties.

The antenna arms 104A, 104B are end-loaded using conductive end plates 106A, 106B to electrically shorten the antenna 101 and provide significant electric field in the Z direction. The conductive end plates 106A, 106B provide the capacitive loading that permits the electrically-short antenna 101 to resonate. The conductive end plates 106A, 106B for antenna 101 are orientated so that the electric field is directed towards the ground rather than between each plate. This tends to increase the area required for each plate. The electrically-small antenna 101 has a high quality factor which gives rise to a large voltage at the ends of antenna arms 104A, 104B. The large voltage on the large conductive end plates 106A, 106B provides a very high electric field under the antenna 101.

End loading the antenna 101 to couple energy to the ground reduces the quality factor of the antenna. Because the conductive end plates 106A, 106B are directed towards the ground, significant electric field is directed towards and coupled into the ground. The high coupling with the ground and the lossy nature of the ground serve to reduce the Q of the antenna. In order to prevent corona discharge when operating at high powers, the shape of the conductive end plates 106A, 106B needs to be considered. The voltage at the ends of the antenna arms 104A, 104B will be approximately Q times the feed voltage, where Q is the Quality factor of the antenna 101. An electrically-small antenna, with inductive and capacitive loading to make it resonate, will have a large Q, and the voltage at the ends of the antenna arms 104A, 104B will be considerable. In order to prevent corona discharge, the ends of the conductive end plates 106A, 106B are shaped with a suitably large radius of curvature. Any other features must be blended to avoid points or sharp protrusions.

The conductive end plates 106A, 106B of the antenna 101 will be at a high voltage in use. The conductive wires 107A, 107B between the coils 105A, 105B and conductive end plates 106A, 106B will be at a lower voltage. The higher voltage conductive end plates 106A, 106B will effectively shadow the conductive wires 107A, 107B near to where the wires join the conductive end plates 106A, 106B. This means that features such as supporting brackets for supporting arms 112A, 112B may be fixed to the conductive wires 107A, 107B close to the conductive end plates 106A, 106B with less chance of corona discharge.

In an alternative embodiment, the conductive end plates could be arranged so that field is constrained between the plates. However, the above-described embodiment results in more energy being coupled to the ground.

In one or more embodiments, the balun 201 is electrically shortened using the high voltage capacitor 111. The current in the conductors is at a maximum at or adjacent a connection with the feed structure. The voltage in the conductors is at a maximum at the distal ends each respective conductor. The feed structure is arranged such that the antenna feed currents flow on the inside of the coaxial feed line 108. The balun currents flow on the outside surface of the coaxial feed line 108. The capacitive plates 106A, 106B and inductive coils provide loading which makes the antenna's input impedance real. The orientation and winding direction are selected to maximise coupling between coils so total inductance is minimised. The capacitive plates electrical shorten the antenna and provide significant E field in the z direction. The end plates may be 100 mm thick and the radius may by 50 mm.

The present invention is not limited by the aforementioned description, and any practical variations within the spirit and scope of the claims are permissible.

1. A dipole antenna, comprising:
a dipole arrangement comprising at least a pair of antenna arms, each antenna arm having a feed end and a distal end, the feed ends positioned in proximity to each other; and
a feed structure, coupled to said dipole arrangement, comprising a balun for providing the antenna with a balanced feed; wherein, each antenna arm comprises:
a conductive end plate, located at the distal end of the respective antenna arm; and
an inductive coil, located at the feed end of the respective antenna arm.

2. A dipole antenna according to claim 1, wherein each antenna arm further comprises a conductive wire, located between the feed end and the conductive end plate; wherein said inductive coil is formed in said conductive wire.

3. A dipole antenna according to claim 1, wherein the feed structure comprises a coaxial transmission line, having an inner conductor and an outer conductor.

4. A dipole antenna according to claim 3, wherein said inner conductor is coupled to a first antenna arm of said pair of antenna arms, and said outer conductor is coupled to a second antenna arm of said pair of antenna arms.

5. A dipole antenna according to claims 4, wherein said feed structure further comprises a conductive cylinder, positioned adjacent said coaxial transmission line.

6. A dipole antenna according to claim 5, wherein said conductive cylinder and said coaxial transmission line are arranged substantially in parallel.

7. A dipole antenna according to claim 6, wherein said inner conductor is connected to said conductive cylinder at a feed end of said feed structure by a coupling member.

8. A dipole antenna according to claim 7, wherein said first antenna arm is connected to said conductive cylinder, and coupled to said inner conductor via said conductive cylinder and said coupling member.

9. A dipole antenna according to claim 8, wherein said feed structure further comprises a high-power capacitor, coupled between the conductive cylinder and said outer conductor of said coaxial transmission line, at said feed end of said feed structure.

10. A dipole antenna according to claim 9, wherein the balun is a twin-line balun, and a first line of said balun is formed by said conductive cylinder and a second line of said balun is formed by said outer surface of the outer conductor of said coaxial feed line.

11. A dipole antenna according to claim 10, wherein said conductive cylinder and outer conductor are coupled to ground at an end of the feed structure distal from said feed end.

12. An antenna according to claim 1, wherein the inductive coils are wound in the same direction.

13. An antenna according to claim 1, wherein the conductive end plate of each antenna arm have rounded corners.

14. An antenna according to claim 13, wherein the corners of said conductive end plates have large radii compared with size of the plates.

15. A dipole antenna according to claim 1, wherein each antenna arm extends along a primary axis, and said axes are arranged to be substantially aligned with a common plane.

16. A dipole antenna according to claim 15, wherein said primary axes are substantially aligned, each antenna arm extending away from said feed point in substantially opposing directions.

17. A dipole antenna according to claim 1, wherein the conductive end plates and inductive coils are arranged to load the antenna such that the antenna resonates at a frequency whose wavelength is long compared to the size of the antenna.

18. A dipole antenna according to claim 1, wherein said antenna is an electrically-short, said dipole is an electrically-short dipole, and the antenna is suitable for a high-power RF input.

19. A dipole antenna according to claim 17, wherein ka<1 , where k, the wave number, is 2π/λ and a is half the length of the antennas longest dimension.

20. A dipole antenna according to claim 1, wherein the balun is a DC ground for the antenna.

21. An antenna arrangement, comprising: the antenna of claim 1; and a supporting structure for supporting the antenna, wherein the antenna is connected to the supporting structure.

22. An antenna arrangement of claim 21, wherein said supporting structure is arranged to support said antenna such that said antenna arms positioned substantially horizontally and parallel to the ground.

23. An antenna arrangement according to claim 22, wherein said antenna is supported such that said conductive end plates are orientated substantially horizontally and parallel to the ground.

24. An antenna arrangement according to claim 23, further comprising a pair of supporting arms.

25. An antenna arrangement according to claim 24, wherein said a first end of each supporting arm is connected to a respective one of said antenna arms, at a position between the inductive coil and the conductive end plate.

26. A vehicle comprising the antenna arrangement of claim 21.

27. A vehicle according to claim 26, wherein the antenna arrangement is positioned at a front end of the vehicle.
